(19) United States
(12) Patent Application Publication
(10) Pub. No.: US 2014/0280273 A1
(43) Pub. Date: Sep. 18, 2014

(54) ANIMAL ABNORMALITY DETECTING DEVICE, AND ANIMAL ABNORMALITY DETECTING METHOD

(71) Applicant: YAHOO JAPAN CORPORATION, Tokyo (JP)

(72) Inventor: Kota TSUBOUCHI, Tokyo (JP)

(73) Assignee: YAHOO JAPAN CORPORATION, Tokyo (JP)

(21) Appl. No.: 14/155,938

(22) Filed: Jan. 15, 2014

(30) Foreign Application Priority Data
Mar. 15, 2013 (JP) 2013-053030

(51) Int. Cl. G06F 17/30

(52) U.S. Cl. CPC G06F 17/30386
USPC 707/758

(57) ABSTRACT

An animal abnormality detecting device includes an animal abnormality information storage unit, a retrieval observation data receiving unit, an animal abnormality information specifying unit, and an abnormality information transmitting unit. In the animal abnormality information storage unit, animal abnormality information including animal observation data including one or more pieces of time-series observation data on an animal and animal individual information is stored. The retrieval observation data receiving unit receives retrieval animal observation data including one or more pieces of time-series observation data on an animal and retrieval animal individual information. The animal abnormality information specifying unit specifies the animal abnormality information including the animal observation data and the animal individual information corresponding to the retrieval animal observation data and the retrieval animal individual information. The abnormality information transmitting unit transmits abnormality information when the animal abnormality information specifying unit specifies the animal abnormality information.

### CROSS-REFERENCE TO RELATED APPLICATIONS

The present application claims priority to and incorporates by reference the entire contents of Japanese Patent Application No. 2013-053030 filed in Japan on Mar. 15, 2013.

### BACKGROUND OF THE INVENTION

1. Field of the Invention

The present invention relates to an animal abnormality detecting device and the like which detect abnormality of an animal.

2. Description of the Related Art

Conventionally, a device and the like which monitors the animal has been developed. Such a device and the like detect an abnormal state by using a sensor to the animal (for example, refer to Japanese Laid-open Patent Publication No. 2012-93936).

However, the conventional device and the like which monitor the animal have a problem that the abnormality of only a specific type of animal may be detected.

### SUMMARY OF THE INVENTION

It is an object of the present invention to at least partially solve the problems in the conventional technology.

According to one aspect of an embodiment, an animal abnormality detecting device includes an animal abnormality information storage unit, a retrieval observation data receiving unit, an animal abnormality information specifying unit, and an abnormality information transmitting unit. In the animal abnormality information storage unit, animal abnormality information including animal observation data including one or more pieces of time-series observation data on an animal and animal individual information being information regarding an individual attribute of the animal is stored. The retrieval observation data receiving unit receives retrieval animal observation data including one or more pieces of time-series observation data on an animal and retrieval animal individual information regarding the individual attribute of the animal. The animal abnormality information specifying unit specifies the animal abnormality information including the animal observation data and the animal individual information corresponding to the retrieval animal observation data and the retrieval animal individual information received by the retrieval observation data receiving unit. The abnormality information transmitting unit transmits abnormality information being information regarding abnormality when the animal abnormality information specifying unit specifies the animal abnormality information.

According to another aspect of an embodiment, an animal abnormality detecting method is performed with an animal abnormality information storage unit in which animal abnormality information including animal observation data including one or more pieces of time-series observation data on an animal and animal individual information being information regarding an individual attribute of the animal is stored. The method includes: receiving retrieval animal observation data including one or more pieces of time-series observation data on an animal and retrieval animal individual information regarding the individual attribute of the animal; specifying the animal abnormality information including the animal observation data and the animal individual information corresponding to the retrieval animal observation data and the retrieval animal individual information received at the receiving; and transmitting abnormality information being information regarding abnormality when the animal abnormality information is specified at the specifying.

According to still another aspect of an embodiment, a computer readable storage medium has stored therein a program which allows a computer capable of accessing an animal abnormality information storage unit in which animal abnormality information including animal observation data including one or more pieces of time-series observation data on an animal and animal individual information being information regarding an individual attribute of the animal is stored to execute a process. The process includes: receiving retrieval animal observation data including one or more pieces of time-series observation data on an animal and retrieval animal individual information regarding the individual attribute of the animal; specifying the animal abnormality information including the animal observation data and the animal individual information corresponding to the retrieval animal observation data and the retrieval animal individual information received in the receiving; and transmitting abnormality information being information regarding abnormality when the animal abnormality information is specified in the specifying.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a system including an animal abnormality detecting device according to a first embodiment;

FIG. 2 is a block diagram of the animal abnormality detecting device according to the first embodiment;

FIG. 3 is a view of an example of sensor data stored in a sensor data storage unit of the first embodiment;

FIG. 4 is a view for illustrating a method in which a feature amount data obtaining unit of the first embodiment obtains a feature amount;

FIG. 5 is a view for illustrating a method in which a state label setting unit and a behavior label setting unit of the first embodiment set labels;

FIG. 6 is a view for illustrating a method in which a state rule obtaining unit and a behavior rule obtaining unit of the first embodiment obtain rules;

FIG. 7 is a flowchart of operation of the animal abnormality detecting device of the first embodiment;

FIG. 8 is a view of an example of animal abnormality information stored in an animal abnormality information storage unit of the first embodiment;

FIG. 9 is a view of an example of animal type information stored in an animal type information storage unit of the first embodiment;

FIG. 10 is a view of an example of display of a user terminal device of the first embodiment;

FIG. 11 is a view of an example of an appearance of a computer system of the first embodiment; and

FIG. 12 is a view of an example of a configuration of the computer system of the first embodiment.

### DETAILED DESCRIPTION OF THE PREFERRED EMBODIMENTS

An embodiment of an animal abnormality detecting device and the like is hereinafter described with reference to the drawings. Meanwhile, in the embodiment, components to which a same reference sign is assigned perform similar operation, so that a repetitive description thereof is sometimes omitted.

In the first embodiment, an animal abnormality detecting device 1 which receives time-series data on an animal to retrieve animal abnormality information corresponding to the time-series data and transmits abnormality information when the animal abnormality information is specified is described.

FIG. 1 is a schematic diagram of a system including the animal abnormality detecting device 1 of the first embodiment. The system including the animal abnormality detecting device 1 includes the animal abnormality detecting device 1 and a user terminal device 2. The system including the animal abnormality detecting device 1 may further include a medical specialist terminal device 3. In FIG. 1, the animal abnormality detecting device 1, one or more user terminal devices 2, and one or more medical specialist terminal devices 3 are connected to one another through a network 100. The network 100 being a wired or wireless communication line is the Internet, an intranet, a LAN (local area network), a public phone line and the like, for example. Any terminal connectable to the network 100 may be used as the user terminal device 2 and the medical specialist terminal device 3. For example, the user terminal device 2 and the medical specialist terminal device 3 may be a desktop personal computer, a notebook personal computer, a smartphone, a PDA and the like. Meanwhile, the user terminal device 2 is a terminal capable of obtaining information obtained by a sensor such as a camera, a microphone, and a temperature indicator. The user terminal device 2 may obtain the information obtained by the sensor through a wired or wireless connecting unit or obtain the information obtained by the sensor through a storage medium such as a memory card. Each sensor obtains the information of the animal such as a squirrel.

FIG. 2 is a block diagram of the animal abnormality detecting device 1 of the first embodiment. The animal abnormality detecting device 1 is provided with an animal abnormality information storage unit 101, a retrieval observation data receiving unit 102, an animal type information storage unit 103, an animal abnormality information specifying unit 104, an abnormality information transmitting unit 105, a sensor data storage unit 106, a feature amount data obtaining unit 107, a state rule obtaining unit 108, a behavior rule obtaining unit 109, and an animal abnormality information accumulating unit 110. The state rule obtaining unit 108 is provided with a state label setting unit 21 and a state rule specifying unit 22. The behavior rule obtaining unit 109 is provided with a behavior label setting unit 23 and a behavior rule specifying unit 24.

One or more pieces of animal abnormality information are stored in the animal abnormality information storage unit 101. The animal abnormality information includes animal observation data including one or more pieces of time-series observation data on the animal and animal individual information being information regarding an individual attribute of the animal. Meanwhile, the animal observation data is preferably the observation data in an abnormal state. The “abnormal state” is a state with medical or surgical disease. The time-series observation data is data formed of continuous data obtained by various sensors at a predetermined interval. The predetermined interval may be constant or inconstant. The predetermined interval may be an interval of once every second or an interval of once every 10 seconds, for example. The predetermined interval may be an interval necessary for obtaining a state rule or a behavior rule or shorter. Although a moving image of an observation target taken by the camera, a sound obtained by collecting a sound emitted by the observation target by the microphone and the like are preferable as the time-series observation data on the animal, any data obtained by using the various sensors may be used. For example, the time-series observation data on the animal may be time-series data indicating a body temperature measured by thermography, time-series data on a position obtained by a GPS attached to the target, time-series data indicating an angle of the target obtained by a gyro sensor attached to the target, and time-series data on a pulse obtained by a pulse monitor attached to the observation target being the animal. Meanwhile, the sound emitted by the observation target may be a voice such as a cry emitted by the observation target or the sound generated by an action of the observation target. The sound generated by the action of the observation target may be a sound generated when the squirrel cracks sunflower seeds, a water sound and the like generated when a raccoon washes food, or may be a sound generated when a tire of a vehicle rubs against a road surface. The time-series observation data on the animal obtained by using the various sensors may be the data obtained by using the various sensors itself or data calculated from the data obtained by using the various sensors. Observation data being the data calculated from the data obtained by using the sensors may be time-series three-dimensional coordinate data and the like indicating a motion history of the observation target obtained by using two or more video cameras, for example. The time-series observation data may also be data obtained by converting the data obtained by the above-described sensors to data in a different format. The data converted to the different format may be feature amount data obtained by dividing waveform data obtained by the sensor into predetermined periods and arranging respective characteristic values in the divided periods in chronological order or data obtained by classifying the characteristic values and arranging labels obtained by assigning the label to each classification in chronological order. The feature amount data and the data in which the labels are arranged in chronological order are described later in detail.

The animal individual information is information including a plurality of pieces of information regarding the individual attribute of the animal. For example, the information regarding the attribute included in the animal individual information may be information indicating a type of the animal, information indicating sex of the animal, information indicating age of the animal, information indicating a disease history of the animal, information indicating size of the animal, information indicating weight of the animal and the like. The animal individual information is a target retrieved by using information received by the retrieval observation data receiving unit 102. Meanwhile, each piece of information regarding the attribute may have only one value or a plurality of values. The information indicating the type of the animal may have only “squirrel” or have “squirrel” and “chipmunk”, for example. The information indicating the age of the animal may have only “four-year-old” or have “four-year-old” and “five-year-old”, for example. The animal individual information may include two types of information: information which should necessarily match for the animal individual information to be found and information which needs not match for the animal individual information to be found if another piece of information matches at the time of retrieval. The information which should necessarily match for the animal individual information to be found may be the type of the animal, for example. The information which needs not match for the animal individual information to be found if another piece of information matches may be the age, the disease history, the weight and the like of the animal. Meanwhile, in this case, when the information regarding the attribute has a plurality of values, if one or more of the values match, it may be said that there is a match.

The animal abnormality information may also include environment observation data being observation data regarding an external environment around the same time as the animal observation data included in the animal abnormality information. The external environment is a phenomenon regarding a peripheral environment of the observation target. The peripheral environment may be any environment in an area having an effect on the observation target. The peripheral environment may be a peripheral area of a cage of the target, a room in which the cage is arranged and the like. The environment observation data may be any data regarding the external environment obtained by using the various sensors. For example, the environment observation data may be the moving image taken by the camera, the time-series data indicating the sound collected by the microphone, time-series data indicating a temperature obtained by the temperature indicator, time-series data indicating precipitation obtained by a rain gauge, time-series data indicating atmospheric pressure obtained by a barometer, time-series data indicating wind strength obtained by a wind gauge and the like. The environment observation data obtained by using the various sensors may be the data obtained by using the various sensors itself or data calculated from the data obtained by using the various sensors. The environment observation data being the data calculated from the data obtained by using the sensor may be time-series data indicating difference between a current temperature and the temperature of few hours ago calculated from a temperature history obtained by the temperature indicator or time-series data indicating temperature difference calculated from a room temperature and an outdoor temperature obtained by two or more temperature indicators, for example. All of the sensors used for obtaining the time-series observation data on the animal and the environment observation data are known technology, so that the detailed description thereof is omitted. The environment observation data may be data obtained by converting the data obtained by the above-described sensors to data in a different format. The data converted to the different format may be external environment feature amount data obtained by dividing waveform data obtained by the sensor into predetermined periods and arranging respective characteristic values in the divided periods in chronological order, data obtained by classifying the characteristic values and arranging labels obtained by assigning the label to each classification in chronological order, one characteristic value, or one characteristic label. The feature amount data and the data in which the labels are arranged in chronological order are described later in detail.

The animal abnormality information may also include animal abnormality detection information indicating content of abnormality corresponding to the animal observation data included in the animal abnormality information. The animal abnormality detection information is the content of the abnormality obtained from the animal observation data. For example, the animal abnormality detection information may be “not walk normally”, “lie down without moving” and the like. The animal abnormality detection information may be stored in the animal abnormality information storage unit 101 by using information which associates a waveform of the animal observation data, the feature amount data, or an arrangement of the labels with the animal abnormality detection information stored in a storage unit not illustrated, or the animal abnormality detection information determined by a human may be accepted by an accepting unit not illustrated and thereafter accumulated in the animal abnormality information storage unit 101 by an accumulating unit not illustrated.

The animal abnormality information may also include diagnostic information indicating a diagnostic result of a medical specialist corresponding to the animal observation data included in the animal abnormality information. The medical specialist may be a veterinarian or one who has medical knowledge about the animal to be diagnosed other than the veterinarian. The medical specialist may diagnose through reading the animal observation data or may diagnose the animal whose animal observation data is obtained. The diagnostic information transmitted from the medical specialist terminal device 3 may be received by a receiving unit not illustrated and thereafter accumulated by the accumulating unit not illustrated in the animal abnormality information storage unit 101.

Meanwhile, when the animal abnormality information accumulating unit 110 accumulates the animal abnormality information, the animal observation data including two or more pieces of observation data is stored in the animal abnormality information storage unit 101. The observation data in this case is the feature amount data or the data in which the labels are arranged in chronological order.

Although a non-volatile recording medium is preferable as the animal abnormality information storage unit 101, a volatile recording medium may also realize the same. The animal abnormality information may be accumulated by the animal abnormality information accumulating unit 110, accumulated through the recording medium, or accumulated by the accumulating unit not illustrated after the animal abnormality information transmitted through a communication line and the like is received by the receiving unit not illustrated.

The retrieval observation data receiving unit 102 receives retrieval animal observation data including one or more pieces of time-series observation data on the animal and retrieval animal individual information regarding the individual attribute of the animal. The information received by the retrieval observation data receiving unit 102 includes the information obtained through constant monitoring of the animal by the user terminal device 2 and the information selectively obtained within a specific period. That is to say, the retrieval observation data receiving unit 102 may continuously receive the animal observation data and the like or may receive the animal observation data within the specific period from the user terminal device 2. The selectively obtained information may be the information within a period in which the user determines that the animal is in an abnormal state or the information within a scheduled period. The information within the scheduled period may be the information obtained within a determined period such as from 12:00 to 12:10 every day, for example. The retrieval observation data receiving unit 102 may receive the retrieval animal observation data, the retrieval animal individual information, and retrieval environment observation data being the observation data regarding the external environment around the same time as the retrieval animal observation data. The retrieval animal observation data may be data obtained by the sensor or data obtained based on the data obtained by the sensor. The retrieval animal observation data received by the retrieval observation data receiving unit 102 is the data which becomes a retrieval key for retrieving the animal observation data stored in the animal abnormality information storage unit 101. Therefore, a detail of the retrieval animal observation data is similar to that of the animal observation data. Although the retrieval animal observation data is preferably the data in the same format as the animal observation data, this may be the data in a different format. The retrieval animal individual information may be the information input by a user with the user terminal device 2 or the information set in advance by the user terminal device 2. The retrieval animal individual information received by the retrieval observation data receiving unit 102 is the data which becomes a retrieval key for retrieving the animal individual information stored in the animal abnormality information storage unit 101. The retrieval animal individual information is information including a plurality of pieces of information regarding the individual attribute of the animal. For example, the information regarding the attribute included in the retrieval animal individual information may be the information indicating the type of the animal, the information indicating the sex of the animal, the information indicating the age of the animal, the information indicating the disease history of the animal, the information indicating the size of the animal, the information indicating the weight of the animal and the like. The retrieval environment observation data received by the retrieval observation data receiving unit 102 is the data which becomes a retrieval key for retrieving the environment observation data stored in the animal abnormality information storage unit 101. A detail of the retrieval environment observation data is similar to that of the environment observation data. Although the retrieval environment observation data is preferably the data in the same format as the environment observation data, this may be the data in a different format.

The retrieval observation data receiving unit 102 may receive the retrieval animal observation data and the retrieval animal individual information while associating them with each other. To receive while associating may be to receive the retrieval animal observation data and the retrieval animal individual information at the same time, to receive the retrieval animal observation data and the retrieval animal individual information including an identical ID separately, or to sequentially receive the retrieval animal observation data and the retrieval animal individual information. Although the retrieval observation data receiving unit 102 is realized by a wireless or wired communicating unit in general, this may also be realized by a unit of receiving broadcast.

One or more pieces of animal type information are stored in the animal type information storage unit 103. The animal type information is information indicating the types of similar animals. The animal type information may be represented in any manner as long as this is the information capable of representing that the type of a certain animal and the type of a different animal are similar to each other. For example, the animal type information may be represented to indicate the types of similar animals by one-to-one correspondence such as “chipmunk, Hokkaido squirrel” and “chipmunk, Japanese squirrel” or may be represented by grouping a plurality of types of animals such as “chipmunk, Hokkaido squirrel, Japanese squirrel, . . . ”. Although a non-volatile recording medium is preferable as the animal type information storage unit 103, a volatile recording medium may also realize the same. A process of storage of the animal type information in the animal type information storage unit 103 is not limited. For example, the animal type information may be stored in the animal type information storage unit 103 through the recording medium, the animal type information transmitted through the communication line and the like may be stored in the animal type information storage unit 103, or the animal type information input through an input device may be stored in the animal type information storage unit 103.

The animal abnormality information specifying unit 104 specifies the animal abnormality information including the animal observation data and the animal individual information corresponding to the retrieval animal observation data and the retrieval animal individual information received by the retrieval observation data receiving unit 102. The animal abnormality information specifying unit 104 may further specify the animal abnormality information including the animal observation data, the animal individual information, and the environment observation data also corresponding to the retrieval environment observation data. When the retrieval animal observation data and the animal observation data correspond to each other and the retrieval animal individual information and the animal individual information correspond to each other, the animal abnormality information specifying unit 104 may specify the animal abnormality information including the animal observation data and the animal individual information. In a case in which the environment observation data is stored in the animal abnormality information storage unit 101 and the retrieval observation data receiving unit 102 also receives the retrieval environment observation data, when the retrieval animal observation data and the animal observation data correspond to each other, the retrieval animal individual information and the animal individual information correspond to each other, and the retrieval environment observation data and the environment observation data correspond to each other, the animal abnormality information specifying unit 104 may specify the animal abnormality information including the animal observation data, the animal individual information, and the environment observation data.

The phrase “the retrieval animal observation data and the animal observation data correspond to each other” may be intended to mean that the retrieval animal observation data and the animal observation data perfectly match each other or that both pieces of data partially match each other. The phrase “both pieces of data partially match each other” may be intended to mean that, when the number of types of the observation data included in the retrieval animal observation data is larger than the number of types of the observation data included in the animal observation data, a part of the types of the observation data included in the retrieval animal observation data match all the types of the observation data included in the animal observation data. The phrase “both pieces of data partially match each other” may also be intended to mean that, when the type of the observation data included in the retrieval animal observation data is different from the type of the observation data included in the animal observation data, the observation data included in the retrieval animal observation data and the observation data included in the animal observation data of a common type match each other. Meanwhile, the term “match” in a case in which correspondence between the retrieval animal observation data and the animal observation data is determined may include an error not larger than a predetermined threshold. For example, when the observation data has a waveform, if the waveform of the observation data included in the retrieval animal observation data and the waveform of the observation data included in the animal observation data rising and falling at same timing are obtained, the animal abnormality information specifying unit 104 may determine that they match each other without consideration of difference in amplitude and, if the same amplitude is obtained, this may determine that they match each other without consideration of a period length. When the observation data is the feature amount data or the arrangement of the labels, if the arrangement of the values of the observation data included in the animal observation data is included in the observation data included in the retrieval animal observation data, it may be determined that they match each other.

The phrase “the retrieval animal individual information and the animal individual information correspond to each other” may be intended to mean that the information included in the retrieval animal individual information and the information included in the animal individual information match each other. For example, this means that the type of the animal of the retrieval animal individual information and the type of the animal of the animal individual information match each other when the type of the animal is included in the retrieval animal individual information and the animal individual information. Meanwhile, the phrase “the retrieval animal individual information and the animal individual information correspond to each other” may be intended to mean that both pieces of information partially match each other. The phrase “both pieces of information partially match each other” may be intended to mean that, when the number of types of the information included in the retrieval animal individual information is larger than the number of types of the information included in the animal individual information, a part of the types of the information included in the retrieval animal individual information match all the types of the information included in the animal individual information. The phrase “both pieces of information partially match each other” may also be intended to mean that, when the type of the information included in the retrieval animal individual information and the type of the information included in the animal individual information are different from each other, the information included in the retrieval animal individual information and the information included in the animal individual information of a common type match each other. Meanwhile, in a case in which each piece of information included in the animal individual information has a plurality of values, when the information included in the retrieval animal individual information matches the information of one out of a plurality of values of the information included in the animal individual information, the animal abnormality information specifying unit 104 may determine that they correspond to each other. When the animal individual information includes the “information which should necessarily match for the animal individual information to be found” and this does not match on this information, it is possible that the animal abnormality information specifying unit 104 does not determine that they correspond even when another piece of information match each piece of information of the retrieval animal individual information. Meanwhile the term “match” in a case in which correspondence between the retrieval animal individual information and the animal individual information is determined may include an error. In a case in which the type of the animal is included in the retrieval animal individual information and the animal individual information and when it is determined whether they match each other on the type of the animal, the animal abnormality information specifying unit 104 may specify the animal abnormality information including the animal individual information including the type of the similar animal in the animal type information and the animal observation data corresponding to the retrieval animal observation data. In a case in which the age of the animal is included in the retrieval animal individual information and the animal individual information and when it is determined whether they match each other on the age of the animal, the animal abnormality information specifying unit 104 may determine that they match each other when difference in age is not larger than a predetermined threshold.

The phrase “the retrieval environment observation data and the environment observation data correspond to each other” is intended to mean that the retrieval environment observation data and the environment observation data match each other. Meanwhile, the term “match” in a case in which correspondence between the retrieval environment observation data and the environment observation data is determined may include an error not larger than a predetermined threshold. For example, when the environment observation data has a waveform, if the waveform of the retrieval environment observation data and the waveform of the environment observation data rising and falling at same timing are obtained, the animal abnormality information specifying unit 104 may determine that they match each other without consideration of difference in amplitude and if the same amplitude is obtained, the animal abnormality information specifying unit 104 may determine that they match each other without consideration of a period length. When the environment observation data is the feature amount data or the arrangement of the labels, if the data of the environment observation data is included in the data of the retrieval environment observation data, it may be determined that they match each other. When the environment observation data is the value of the feature amount data or the label, when the data of the environment observation data is included in the data of the retrieval environment observation data, it may be determined that they match each other. When the animal abnormality information specifying unit 104 determines whether the observation data in the different format corresponds, this determines after converting the same to the same format. When the format of the observation data is converted, the animal abnormality information specifying unit 104 may convert the format by processing by the feature amount data obtaining unit 107, the state rule obtaining unit 108, and the behavior rule obtaining unit 109. The animal abnormality information specifying unit 104 may be realized by a MPU (micro processing unit), a memory and the like in general. A procedure of the animal abnormality information specifying unit 104 is realized by software in general and the software is recorded on a recording medium such as a ROM (read only memory). This may also be realized by hardware (dedicated circuit).

The abnormality information transmitting unit 105 transmits the abnormality information being information regarding the abnormality when the animal abnormality information specifying unit 104 specifies the animal abnormality information. The animal abnormality information is information indicating the abnormality. Meanwhile, the abnormality information may include the animal abnormality detection information included in the animal abnormality information specified by the animal abnormality information specifying unit 104 and the diagnostic information included in the animal abnormality information specified by the animal abnormality information specifying unit 104. The abnormality information transmitting unit 105 may transmit the abnormality information to the user terminal device 2 which transmits the retrieval animal observation data and the like, to another terminal device set in advance by the user, or to a terminal device not illustrated which transmits a transmission request regarding the abnormality information received by a receiving unit not illustrated. The abnormality information transmitting unit 105 may transmit the abnormality information to the medical specialist terminal device 3. Meanwhile, when the abnormality information is transmitted to the medical specialist terminal device 3, it is also possible to transmit each piece of data received by the retrieval observation data receiving unit 102. The abnormality information transmitting unit 105 may be realized by a wireless or wired communicating unit in general.

In the sensor data storage unit 106, sensor data being the data obtained by the sensor when there is the abnormality of the animal and one or more types of time-series data, and the animal individual information being the information regarding the individual attribute of the animal are stored so as to be associated with each other. Time-series sensor data regarding the external environment may also be stored in the sensor data storage unit 106. The sensor data is the data obtained by the various sensors. Although the above-described observation data may be the data itself obtained by using the various sensors or the data calculated based on the data obtained by using the various sensors, the sensor data is the data itself obtained by using the various sensors. A detail of the animal individual information stored in the sensor data storage unit 106 is the same as that of the animal individual information stored in the animal abnormality information storage unit 101.

Two or more types of time-series sensor data may be stored in the sensor data storage unit 106. When two or more types of time-series sensor data are stored in the sensor data storage unit 106, the sensor data as illustrated in FIG. 3 are stored, for example, in the sensor data storage unit 106. Each piece of sensor data stored in the sensor data storage unit 106 is the data including a common period. That is to say, it is preferable that two or more types of time-series sensor data observed within an optional period such as a period from 00:00:00 Jan. 1, 2013 to 00:00:05 Jan. 1, 2013, for example, are stored. The sensor data storage unit 106 preferably stores such that pieces of information of respective pieces of sensor data at a specific time point included in the period common to the pieces of time-series sensor data may be synchronized with each other. In order to synchronize the pieces of time-series sensor data, each piece of time-series sensor data may include information required for synchronization such as a time code, for example. Hereinafter, it is mainly described supposing that the sensor data storage unit 106 stores two types of sensor data on the animal and one type of sensor data regarding the external environment. Although a non-volatile recording medium is preferable as the sensor data storage unit 106, a volatile recording medium may also realize the same. A process of storage of the sensor data in the sensor data storage unit 106 is not limited. For example, the sensor data may be stored in the sensor data storage unit 106 through the recording medium, the sensor data transmitted through the communication line and the like may be stored in the sensor data storage unit 106, or the sensor data input through the input device may be stored in the sensor data storage unit 106. Meanwhile, the “two or more types of sensor data” are intended to mean the pieces of sensor data obtained by two or more types of different sensors.

The feature amount data obtaining unit 107 obtains two or more types of feature amount data being time-series data of the characteristic values from one type of time-series sensor data stored in the sensor data storage unit 106. The feature amount data obtaining unit 107 may also obtain the external environment feature amount data being the time-series data of the characteristic values from the time-series sensor data regarding the external environment. The feature amount data is the data obtained by dividing the sensor data into predetermined periods and arranging the characteristic values in respective divided periods in chronological order as illustrated in FIG. 4, for example. The value of the feature amount data may be a maximum value in the predetermined period, a minimum value in the predetermined period, an average value of the waveform in the predetermined period, inclination of the waveform in the predetermined period, a characteristic value obtained by Fourier transform of the waveform in the predetermined period, a value obtained by differentiating a motion amount in the predetermined period with respect to time, a value obtained by differentiating the motion amount in the predetermined period twice with respect to time, a value obtained by another algorithm and the like. The feature amount data may also be a value associated with the value obtained in the above-described manner. For example, the feature amount data obtaining unit 107 may obtain a value of the feature amount data corresponding to each value obtained in the above-described manner by using a correspondence table stored in a storage unit not illustrated. Specifically, the feature amount data obtaining unit 107 may obtain the feature amount data regarding a sound volume of the cry by using the correspondence table in which the sound volume is divided into five levels of feature amount data. Meanwhile, the feature amount data may be a numerical value obtained by rounding the value obtained in the above-described manner to an optional place. A manner of rounding the value may be rounding off, rounding down, and rounding up.

Meanwhile, when two or more types of time-series observation data on the observation target are stored in the sensor data storage unit 106, the feature amount data obtaining unit 107 may obtain three or more types of feature amount data from the two or more types of time-series sensor data on the observation target stored in the sensor data storage unit 106. When the feature amount data obtaining unit 107 obtains the feature amount data from the two or more types of time-series sensor data, this may obtain two or more types of feature amount data from a certain time-series sensor data and obtain one or more types of feature amount data from each piece of time-series sensor data other than the certain time-series sensor data. That is to say, the feature amount data obtaining unit 107 may obtain (M+1) or more types of feature amount data from M types of time-series sensor data by using each of the M types of time-series sensor data. M is set to a natural number not smaller than one. Therefore, it may be considered that the time-series sensor data used for obtaining the feature amount data which is not used for obtaining the state rule or the behavior rule is not included in the M types of time-series sensor data. Hereinafter, a case in which two or more types of time-series sensor data are stored in the sensor data storage unit 106 is mainly described.

It is possible that the feature amount data obtaining unit 107 obtains or does not obtain state feature amount data being the feature amount data regarding a state and behavior feature amount data being the feature amount data regarding a behavior from the sensor data. Meanwhile, in a case in which two or more types of time-series observation data on the observation target are stored in the sensor data storage unit 106, the feature amount data obtaining unit 107 may obtain N or more types of state feature amount data and (3-N) or more types of behavior feature amount data from the sensor data. N is 1 or 2. The state feature amount data may be the data used for obtaining the state rule. The state rule is information formed of the arrangement of the values of the feature amount data, the labels and the like regarding the state of the animal. The state rule may be information indicating a state during eating, information indicating a state during drinking, information indicating a state during urination, information indicating a state during defecation, information indicating a state during sleep, or information indicating another state, for example. The behavior feature amount data may be the data used for obtaining the behavior rule. The behavior rule is information formed of the arrangement of the values of the feature amount data, the labels and the like regarding a behavior of the animal. The behavior rule may be information indicating a behavior to change position at regular intervals, information indicating a behavior to run, information indicating a behavior to cry, information indicating a behavior to jump and the like, for example. Difference between the state feature amount data and the behavior feature amount data in the processes of obtaining the feature mount data may be difference in the predetermined periods into which the sensor data is divided, difference in the process of obtaining the feature amount data, difference in the sensor data for obtaining the feature amount data, or a combination of two or more of the above-described differences. The difference in a case in which the predetermined periods into which the sensor data is divided are different may be that the predetermined period in the process of obtaining the behavior feature amount data is shorter than the predetermined period in the process of obtaining the state feature amount data. For example, when the predetermined period in the process of obtaining the state feature amount data is 10 seconds, the predetermined period in the process of obtaining the behavior feature amount data may be one second and the like. The difference in a case in which the processes for obtaining the feature amount data are different may be that the process of obtaining the behavior feature amount data is a process of obtaining a differential value while the process of obtaining the state feature amount data is a process of obtaining an integral value, for example. The difference in a case in which the sensor data for obtaining the feature amount data is different may be that the sensor data used for obtaining the state feature amount data and the sensor data used for obtaining the behavior feature amount data are determined to be different from each other in advance. For example, the process by the feature amount data obtaining unit 107 may be determined in advance such that the state feature amount data and the behavior feature amount data are obtained from the camera and the behavior feature amount data is obtained from the microphone.

The “two or more types of feature amount data” may be considered to be two or more pieces of feature amount data obtained by different processes. Meanwhile, when two pieces of feature amount data obtained by the different processes are the same feature amount data, they may be considered to be the two types of feature amount data or one type of feature amount data. The feature amount data obtaining unit 107 may be realized by a MPU, a memory and the like in general. A procedure of the feature amount data obtaining unit 107 is realized by software in general and the software is recorded on a recording medium such as a ROM. This may also be realized by hardware (dedicated circuit).

The state rule obtaining unit 108 obtains the state rule being the rule regarding the state of the target by using the one or more types of feature amount data obtained by the feature amount data obtaining unit 107. When the feature amount data obtaining unit 107 obtains two or more types of feature amount data from the one type of sensor data, the state rule obtaining unit 108 may obtain the state rule by using at least one or more types of the two or more types of feature amount data. When the state rule is obtained from one type of feature amount data, the state rule obtaining unit 108 may obtain the state rule being consecutive values of the feature amount data when two or more consecutive values in the feature amount data repeatedly appear within a predetermined period. Meanwhile, when the feature amount data obtaining unit 107 obtains three or more types of feature amount data from two or more types of time-series sensor data, the state rule obtaining unit 108 may obtain the state rule by using any N or more types of feature amount data out of the three or more types of feature amount data. N is 1 or 2 as described above. When the state rule is obtained from two or more types of feature amount data, the state rule obtaining unit 108 may obtain the state rule being a combination of consecutive values when the combination of one or two or more consecutive values in the two or more types of feature amount data repeatedly appears within a predetermined period. When the feature amount data obtaining unit 107 obtains the state feature amount data, the state rule obtaining unit 108 may obtain the state rule in the above-described manner from the state feature amount data.

The state rule obtaining unit 108 may also obtain the state rule for each value of the external environment feature amount data or each classification of the values of the external environment feature amount data. To “obtain the state rule for each value of the external environment feature amount data” is to obtain the state rule for each value obtained by the feature amount data obtaining unit 107. For example, when the sensor data regarding the external environment is the sensor data regarding the temperature, the state rule obtaining unit 108 may obtain the state rule when the temperature is 30 degrees C. and the state rule when the temperature is 31 degrees C. To “obtain the state rule for each classification of the values of the external environment feature amount data” is to obtain the state rule for each classification by classifying the values obtained by the feature amount data obtaining unit 107 into two or more classifications. For example, when the sensor data regarding the external environment is the sensor data regarding the temperature, the state rule obtaining unit 108 may obtain the state rule when the temperature is not lower than 30 degrees C. and the state rule when the temperature is not lower than 20 degrees C. and lower than 30 degrees C. In addition to the above, the classification of the values of the external environment feature amount data may be the classification of whether it's raining when the sensor data regarding the external environment is the sensor data regarding the precipitation, the classification such as a library level, a daily life noise level, or a construction site level when the sensor data regarding the external environment is the sensor data regarding the sound, or another classification. The state rule obtaining unit 108 may be realized by a MPU, a memory and the like in general. A procedure of the state rule obtaining unit 108 is realized by software in general and the software is recorded on a recording medium such as a ROM. This may also be realized by hardware (dedicated circuit).

The state rule obtaining unit 108 may obtain the state rule by assigning the label to the feature amount data by a process by the state label setting unit 21 and the state rule specifying unit 22. Meanwhile, the term “feature amount data” herein used may be the state feature amount data. The state label setting unit 21 classifies the values of the feature amount data into a plurality of groups and sets an identical state label to the values of the feature amount data belonging to the same group as illustrated in FIG. 5. The state label setting unit 21 may set the state label to any N or more types of feature amount data out of three or more types of feature amount data. N is 1 or 2 as described above. A criterion for the state label setting unit 21 to classify the values of the feature amount data is not limited. For example, the state label setting unit 21 may classify each value of the feature amount data into a group, classify the values of the feature amount data into a group according to a predetermined range of the values, or classify the values of the feature amount data into a group according to a predetermined rule. The predetermined rule may be the rule to classify into a group of even number values of the feature amount data and a group of odd number values of the feature amount data, the rule to classify into a group of frequent values of the feature amount data and a group of other values of the feature amount data and the like. The state label is information capable of identifying the classified group. That is to say, the state label may be any information as long as this is the information capable of uniquely identifying the group. By using the state label, a plurality of values of the feature amount data may be set for one label and the information may be further rounded than in a case in which the values of the feature amount data are used. That is to say, to set the state label makes it easier to find the state rule.

Meanwhile, the state label setting unit 21 may bring two or more consecutive values of the feature amount data together into one group. When the state label setting unit 21 brings two or more consecutive values of the feature amount data together into one group, this may set one state label to the two or more consecutive values of the feature amount data. Specifically, the state label setting unit 21 may bring the values of the feature amount data together such that the arrangement of the values of the feature amount data “value of feature amount data indicating acting state/value of feature amount data indicating stopping state/value of feature amount data indicating stopping state/value of feature amount data indicating acting state” is made “value of feature amount data indicating acting state/value of feature amount data indicating stopping state/value of feature amount data indicating acting state”. When the values of the feature amount data are brought together, the state label setting unit 21 may set the label without regard to a stopping time period in the above-described case, for example.

The state rule specifying unit 22 obtains the state rule from N or more types of arrangements of the state labels set by the state label setting unit 21 as in FIG. 6, for example. In a case in which the state rule is obtained from one type of arrangement of the state labels, the state rule specifying unit 22 may obtain the state rule being consecutive state labels when two or more consecutive state labels in the arrangement of the state labels repeatedly appear within a predetermined period. In a case in which the state rule is obtained from two or more types of arrangements of the state labels, the state rule specifying unit 22 may obtain the state rule being a combination of the consecutive state labels when the combination of one or two or more consecutive state labels in the two or more types of arrangements of the state labels repeatedly appears within a predetermined period. The state rule specifying unit 22 may obtain the state rule by dividing the arrangement of the state labels into a plurality of periods and performing frequent pattern mining or obtain the state rule by changing the periods into which the above-described arrangement of the state labels is divided a plurality of times and similarly performing the frequent pattern mining, for example. Meanwhile, the frequent pattern mining is well-known technology, so that the detailed description thereof is omitted.

The behavior rule obtaining unit 109 obtains the behavior rule being the rule regarding the behavior of the target by using the one or more types of feature amount data obtained by the feature amount data obtaining unit 107. When the feature amount data obtaining unit 107 obtains two or more types of feature amount data from one type of sensor data, the behavior rule obtaining unit 109 may obtain the behavior rule by using at least one or more types out of the two or more types of feature amount data. In a case in which the behavior rule is obtained from one type of feature amount data, the behavior rule obtaining unit 109 may obtain the behavior rule being consecutive values of the feature amount data when two or more consecutive values in the feature amount data repeatedly appear within a predetermined period. Meanwhile, when the feature amount data obtaining unit 107 obtains three or more types of feature amount data from two or more types of time-series sensor data, the behavior rule obtaining unit 109 may obtain the behavior rule by using any (3-N) or more types of feature amount data out of the three or more types of feature amount data. N is 1 or 2 as described above. In a case in which the behavior rule is obtained from two or more types of feature amount data, the behavior rule obtaining unit 109 may obtain the behavior rule being a combination of the consecutive values when the combination of one or two or more consecutive values in the two or more types of feature amount data repeatedly appears within a predetermined period. When the feature amount data obtaining unit 107 obtains the behavior feature amount data, the behavior rule obtaining unit 109 may obtain the behavior rule from the behavior feature amount data. The behavior rule obtaining unit 109 may obtain the behavior rule by using all the pieces of feature amount data which are not used by the state rule obtaining unit 108 out of the pieces of feature amount data obtained by the feature amount data obtaining unit 107, obtain the behavior rule by using one or more pieces of feature amount data, at least a part of the type of which is different from the type of the feature amount data used by the state rule obtaining unit 108, or obtain the behavior rule by using one or more pieces of feature amount data satisfying both of the above. That is to say, the state rule obtaining unit 108 and the behavior rule obtaining unit 109 may perform the process such that all the pieces of feature amount data obtained by the feature amount data obtaining unit 107 are used for obtaining the state rule or the behavior rule. The behavior rule may also be the rule within a period in which the state rule is obtained. That is to say, when the state rule obtaining unit 108 obtains the state rule within a period x from a time point t to a time point (t+x), the behavior rule obtaining unit 109 may obtain the behavior rule within a period shorter than the period x from the time point t to the time point (t+x). Meanwhile, x is an optional period.

The behavior rule obtaining unit 109 may also obtain the behavior rule for each value of the external environment feature amount data or each classification of the values of the external environment feature amount data. To “obtain the behavior rule for each value of the external environment feature amount data” is to obtain the behavior rule for each value obtained by the feature amount data obtaining unit 107. For example, when the sensor data regarding the external environment is the sensor data regarding the temperature, the behavior rule obtaining unit 109 may obtain the behavior rule when the temperature is 30 degrees C. and the behavior rule when the temperature is 31 degrees C. To “obtain the behavior rule for each classification of the values of the external environment feature amount data” is to obtain the behavior rule for each classification by dividing the values obtained by the feature amount data obtaining unit 107 into two or more classifications. For example, when the sensor data regarding the external environment is the sensor data regarding the temperature, the behavior rule obtaining unit 109 may obtain the behavior rule when the temperature is not lower than 30 degrees C. and the behavior rule when the temperature is not lower than 20 degrees C. and lower than 30 degrees C. In addition to the above, the classification of the values of the external environment feature amount data may be the classification of whether it's raining when the sensor data regarding the external environment is the sensor data regarding the precipitation, the classification such as the library level, the daily life noise level, or the construction site level when the sensor data regarding the external environment is the sensor data regarding the sound, or another classification. The behavior rule obtaining unit 109 may be realized by a MPU, a memory and the like in general. A procedure of the behavior rule obtaining unit 109 is realized by software in general and the software is recorded on a recording medium such as a ROM. This may also be realized by hardware (dedicated circuit).

The behavior rule obtaining unit 109 may obtain the behavior rule by assigning the label to the feature amount data by a process by the behavior label setting unit 23 and the behavior rule specifying unit 24. Meanwhile, the term “feature amount data” herein used may be the behavior feature amount data. The behavior label setting unit 23 classifies the values of the feature amount data into a plurality of groups and sets an identical behavior label to the values of the feature amount data belonging to the same group as illustrated in FIG. 5. The behavior label setting unit 23 may set the behavior label to any (3-N) or more types of feature amount data out of three or more types of feature amount data. N is 1 or 2 as described above. A criterion for the behavior label setting unit 23 to classify the values of the feature amount data is not limited. For example, the behavior label setting unit 23 may classify each value of the feature amount data into a group, classify the values of the feature amount data into a group according to a predetermined range of the values, or classify the values of the feature amount data into a group according to a predetermined rule. The predetermined rule may be the rule to classify into a group of even number values of the feature amount data and a group of odd number values of the feature amount data, the rule to classify into a group of frequent values of the feature amount data and a group of other values of the feature amount data and the like. The behavior label is information capable of identifying the classified group. That is to say, the behavior label may be any information as long as this is the information capable of uniquely identifying the group. By using the behavior label, a plurality of values of the feature amount data may be set for one label and the information may be further rounded than in a case in which the values of the feature amount data are used. That is to say, to set the behavior label makes it easier to find the behavior rule.

Meanwhile, the behavior label setting unit 23 may bring two or more consecutive values of the feature amount data together into one group. When the behavior label setting unit 23 brings two or more consecutive values of the feature amount data together into one group, this may set one behavior label to the two or more consecutive values of the feature amount data. Specifically, the behavior label setting unit 23 may bring the values of the feature amount data together such that the arrangement of the values of the feature amount data “value of feature amount data indicating behavior to run/value of feature amount data indicating behavior to walk/value of feature amount data indicating behavior to walk/value of feature amount data indicating behavior to run” is made “value of feature amount data indicating behavior to run/value of feature amount data indicating behavior to walk/value of feature amount data indicating behavior to run”. When the values of the feature amount data are brought together, the behavior label setting unit 23 may set the label without regard to a walking time period in the above-described case, for example.

The behavior rule specifying unit 24 obtains the behavior rule from (3-N) types of arrangements of the behavior labels set by the behavior label setting unit 23 as in FIG. 6, for example. N is 1 or 2 as described above. In a case in which the behavior rule is obtained from one type of arrangement of the behavior labels, the behavior rule specifying unit 24 may obtain the behavior rule being consecutive behavior labels when two or more consecutive behavior labels in the arrangement of the behavior labels repeatedly appear within a predetermined period. When the behavior rule is obtained from two or more types of arrangements of the behavior labels, the behavior rule specifying unit 24 may obtain the behavior rule being a combination of the consecutive behavior labels when the combination of one or two or more consecutive behavior labels in the two or more types of arrangements of the behavior labels repeatedly appears within a predetermined period. The behavior rule specifying unit 24 may obtain the behavior rule by dividing the arrangement of the behavior labels into a plurality of periods and performing the frequent pattern mining or obtain the behavior rule by changing the periods into which the above-described arrangement of the behavior labels is divided a plurality of times and similarly performing the frequent pattern mining, for example.

The animal abnormality information accumulating unit 110 accumulates the animal abnormality information including the animal observation data including one or two or more types of observation data being the state rule obtained by the state rule obtaining unit 108 and one or two or more types of observation data being the behavior rule obtained by the behavior rule obtaining unit 109 and the animal individual information associated with the sensor data used when the observation data is obtained in the animal abnormality information storage unit 101. The animal abnormality information accumulating unit 110 may accumulate the animal abnormality information including the values of the external environment feature amount data or the classification of the values of the external environment feature amount data in the animal abnormality information storage unit 101. Meanwhile, when the animal abnormality information specifying unit 104 specifies the animal abnormality information accumulated by the animal abnormality information accumulating unit 110, the retrieval animal observation data received by the retrieval observation data receiving unit 102 is one or more pieces of waveform data, two or more pieces of feature amount data, or the arrangement of the labels obtained by classifying two or more feature amount data. The animal abnormality information accumulating unit 110 may be realized by a MPU, a memory and the like in general. A procedure of the animal abnormality information accumulating unit 110 is realized by software in general and the software is recorded on a recording medium such as a ROM. This may also be realized by hardware (dedicated circuit).

FIG. 7 is a flowchart illustrating an example of operation of the animal abnormality detecting device 1 of this embodiment. Hereinafter, the operation is described with reference to FIG. 7. Meanwhile, a case in which two or more types of sensor data on the observation target are stored in the sensor data storage unit 106 is described in this flowchart.

(Step S201) The retrieval observation data receiving unit 102 determines whether the retrieval animal observation data, the retrieval animal individual information, and the retrieval environment observation data are received. When they are received, the procedure shifts to step S202, and when they are not received, the procedure shifts to step S206.

(Step S202) The animal abnormality information specifying unit 104 retrieves the animal abnormality information corresponding to the retrieval animal observation data and the like received at step S201.

(Step S203) The abnormality information transmitting unit 105 determines whether there is the animal abnormality information corresponding to the retrieval animal observation data received at step S201 as a result of retrieval at step S202. When there is the corresponding animal abnormality information, the procedure shifts to step S204, and when there is not the corresponding animal abnormality information, the procedure returns to step S201.

(Step S204) The abnormality information transmitting unit 105 transmits the abnormality information specified as the result of the retrieval at step S202 to a terminal which transmits the retrieval animal observation data and the like received at step S201.

(Step S205) The abnormality information transmitting unit 105 transmits the abnormality information specified as the result of the retrieval at step S202 to the medical specialist terminal device 3. Then, the procedure returns to step S201.

(Step S206) It is determined whether the sensor data is stored in the sensor data storage unit 106. When the sensor data is stored, the procedure shifts to step S207, and when this is not stored, the procedure returns to step S201.

(Step S207) The feature amount data obtaining unit 107 obtains three or more types of feature amount data from two types of sensor data stored in the sensor data storage unit 106.

(Step S208) The feature amount data obtaining unit 107 obtains the external environment feature amount data from the sensor data regarding the external environment stored in the sensor data storage unit 106.

(Step S209) The state label setting unit 21 classifies the feature amount data obtained at step S207 into groups according to a value of the feature amount data and sets the state label for each classified group.

(Step S210) The state rule specifying unit 22 specifies the state rule for each value of the external environment feature amount data from the arrangement of the state labels set at step S209.

(Step S211) The behavior label setting unit 23 classifies the feature amount data obtained at step S207 into a group according to a value of the feature amount data and sets the behavior label for each classified group.

(Step S212) The behavior rule specifying unit 24 specifies the behavior rule for each value of the external environment feature amount data from the arrangement of the behavior labels set at step S211.

(Step S213) The animal abnormality information accumulating unit 110 accumulates the animal abnormality information including the animal observation data including the state rule specified at step S210 and the behavior rule specified at step S212, the animal individual information associated with the sensor data used when the animal observation data is obtained, and the classification of the values of the external environment feature amount data in the animal abnormality information storage unit 101. Meanwhile, the animal abnormality information accumulating unit 110 deletes the sensor data used when the animal observation data included in the accumulated animal abnormality information is obtained from the sensor data storage unit 106. Then, the procedure returns to step S201.

Specific operation of the animal abnormality detecting device 1 of this embodiment is hereinafter described. Meanwhile, information in each drawing illustrated in this specific example prepared as a matter of convenience for description does not illustrate actual data. In this specific example, the animal abnormality information is stored in the animal abnormality information storage unit 101 by performing the processes at steps S206 to S213 in the flowchart.

In this specific example, a table illustrated in FIG. 8 is stored in the animal abnormality information storage unit 101. The table in FIG. 8 includes an animal abnormality information ID, the observation data, the observation data regarding the external environment, the animal abnormality detection information, the animal individual information, and the diagnostic information. For example, in an animal abnormality information ID “1”, observation data “[state rule: a1 a2 a1], [behavior rule: b1 b3 b2], [behavior rule: c3 c1 c1]”, observation data regarding the external environment “D3”, animal abnormality detection information “stop moving at regular intervals”, animal individual information “[type: dog], [age: six-year-old], [sex: female]”, and diagnostic information “fever” are registered. Meanwhile, in this specific example, the observation data is the rule obtained by the state rule obtaining unit 108 and the behavior rule obtaining unit 109. In this specific example, the observation data regarding the external environment is the classification of the value of the external environment feature amount data obtained by the feature amount data obtaining unit 107.

In this specific example, a table illustrated in FIG. 9 is stored in the animal type information storage unit 103. The table in FIG. 9 includes a type name and a corresponding type name. For example, a type name “squirrel” and a corresponding type name “chipmunk” are registered as first information. This is the information for the animal abnormality information specifying unit 104 to handle “squirrel” and “chipmunk” as the animal types matching each other.

Suppose that the user noticing abnormality of the squirrel which moves little in the cage captures the data regarding a state of the squirrel from the camera and the microphone and the data regarding the external environment from the temperature indicator to the user terminal device 2, operates the user terminal device 2, and presses a transmission button on a retrieval animal observation data transmission screen. The user terminal device 2 transmits the retrieval animal observation data including two types of waveform observation data of the moving image and the sound, the waveform retrieval environment observation data regarding the temperature, and retrieval animal individual information “[type: squirrel], [age: four-year-old], [sex: male]” registered in advance while associating them with one another. Then, the retrieval animal observation data and the like transmitted from the user terminal device 2 is received by the retrieval observation data receiving unit 102 (step S201).

The animal abnormality information specifying unit 104 converts the waveform observation data received by the retrieval observation data receiving unit 102 to the arrangement of the labels by using the feature amount data obtaining unit 107, the state label setting unit 21 included in the state rule obtaining unit 108, and the behavior label setting unit 23 included in the behavior rule obtaining unit 109. At that time, the animal observation data received by the retrieval observation data receiving unit 102 is converted to “[state rule: a1 a1 a3 a2 a1 a3 a1 a3 a2], [behavior rule: b1 b1 b1 b1 b1 b1 b1 b1 b1], [behavior rule: c4 c1 c4 c1 c4 c1 c4 c1]” and the environment observation data is converted to “D2 D2 D2”. The animal abnormality information specifying unit 104 retrieves the animal abnormality information corresponding to the converted observation data and the retrieval animal individual information. First, the animal abnormality information specifying unit 104 determines that the animal abnormality information ID “1” does not correspond because the retrieval animal individual information and the animal individual information do not at all match each other. Next, the animal abnormality information specifying unit 104 determines about an animal abnormality information ID “2”. The type of the animal individual information of the animal abnormality information ID “2” is “chipmunk” and this is different from the type “squirrel” included in the retrieval animal individual information. However, “squirrel” and “chipmunk” are registered as corresponding type names in the animal type information storage unit 103. Therefore, the animal abnormality information specifying unit 104 determines that the type included in the retrieval animal individual information and the type of the animal individual information of the animal abnormality information ID “2” match each other. The age of the animal individual information of the animal abnormality information ID “2” is “three-year-old” and this is different from the age “four-year-old” included in the retrieval animal individual information. However, difference between “four-year-old” and “three-year-old” is one year and this might be considered as an error range. Therefore, the animal abnormality information specifying unit 104 determines that the age included in the retrieval animal individual information and the age of the animal individual information of the animal abnormality information ID “2” match each other. Further, since the sex included in the retrieval animal individual information and the sex of the animal individual information of the animal abnormality information ID “2” is “male”, the animal abnormality information specifying unit 104 determines that they match each other. Since the observation data of the animal abnormality information ID “2” is included in the retrieval animal observation data and the observation data regarding the external environment is included in the retrieval environment observation data, the animal abnormality information specifying unit 104 specifies the animal abnormality information ID “2” as the corresponding animal abnormality information (step S202).

The abnormality information transmitting unit 105 transmits animal abnormality detection information “not move” and diagnostic information “bone fracture” of the animal abnormality information ID “2” specified by the animal abnormality information specifying unit 104 to the user terminal device 2 (steps S203 and S204). Then, it is displayed on the user terminal device 2 as illustrated in FIG. 10. Then, the abnormality information transmitting unit 105 transmits the animal abnormality detection information “not move” and the diagnostic information “bone fracture” of the animal abnormality information ID “2”, the retrieval animal observation data, the retrieval environment observation data, and the retrieval animal individual information received by the retrieval observation data receiving unit 102 to the medical specialist terminal device 3 (step S205). Then, the retrieval animal observation data, the retrieval animal individual information, the retrieval environment observation data and the like are displayed on the medical specialist terminal device 3.

A process of accumulating the animal abnormality information in the animal abnormality information storage unit 101 in a case in which the sensor data being the moving image obtained by photographing the squirrel in the abnormal state by the camera and the animal individual information of the squirrel are stored in the sensor data storage unit 106 is hereinafter specifically described. Meanwhile, in this specific example, the camera is arranged such that an entire area in the cage may be photographed from above the cage of the squirrel. Suppose that the feature amount data obtaining unit 107 obtains feature amount data regarding a position of the squirrel “A, B, C, C, C, C, A . . . ” and feature amount data regarding a posture of the squirrel “Z, Z, Y, Z, Z, X, Y . . . ” by performing a background differencing process from the sensor data being the moving image. Meanwhile, in this specific example, supposed that “C, C, C, C” appears at regular intervals in the feature amount data regarding the position of the squirrel and further “Z, Z, X” appears at regular intervals in the feature amount data regarding the posture of the squirrel within the same period as “C, C, C, C”. Herein, “C” is a value of the feature amount data indicating a position of a toilet, “Z” is a value of the feature amount data indicating a lying-down state, and “X” is a value of the feature amount data indicating a state of gazing around. The state rule obtaining unit 108 obtains a state rule “C, C, C, C” from the feature amount data regarding the position of the squirrel. The behavior rule obtaining unit 109 obtains a behavior rule “Z, Z, X” corresponding to the state rule “C, C, C, C”. Then, the animal abnormality information accumulating unit 110 forms the animal abnormality information including the animal observation data including the obtained state rule and behavior rule and the animal individual information corresponding to the sensor data used for obtaining the rules to accumulate in the animal abnormality information storage unit 101. Meanwhile, the state rule “C, C, C, C” output in this specific example indicates a state of staying in the toilet and the behavior rule “Z, Z, X” indicates a state of gazing around after lying down for a while.

The process of accumulating the animal abnormality information in the animal abnormality information storage unit 101 in a case in which the sensor data being the moving image obtained by photographing the squirrel in the abnormal state by the camera, the sensor data being the sound obtained by collecting the cry emitted by the squirrel by the microphone, and the animal individual information of the squirrel are stored in the sensor data storage unit 106 is specifically described. Meanwhile, in this specific example, a part of the description overlapping with that of the specific example previously described might be omitted. In this specific example, the microphone is arranged in the close vicinity of the cage of the squirrel. Suppose that the feature amount data obtaining unit 107 obtains the feature amount data regarding the position of the squirrel “A, B, C, C, C, C, A . . . ” and the feature amount data regarding the posture of the squirrel “Z, Z, Y, Z, Z, X, Y . . . ” by performing the background differencing process from the sensor data being the moving image and obtains feature amount data regarding whether the cry is emitted “0, 0, 0, 0, 0, 1, 0 . . . ” from the sensor data being the sound (step S207). Meanwhile, in this specific example, suppose that “0, 0, 1” also appears at regular intervals within a period in which “Z, Z, X” appears within the period in which “C, C, C, C” appears. Herein, “0” is a value of the feature amount data indicating that the cry is not emitted and “1” is a value of the feature amount data indicating that the cry is emitted. The state rule obtaining unit 108 obtains the state rule “C, C, C, C” from the feature amount data regarding the position of the squirrel (steps S209 and S210). The behavior rule obtaining unit 109 obtains a behavior rule [“Z, Z, X”, “0, 0, 1”] corresponding to the state rule “C, C, C, C” (steps S211 and S212). Then, the animal abnormality information accumulating unit 110 forms the animal abnormality information including the animal observation data including the obtained state rule and behavior rule and the animal individual information corresponding to the sensor data used for obtaining the rules to accumulate in the animal abnormality information storage unit 101 (step S213). Meanwhile, the state rule “C, C, C, C” output in this specific example indicates the state of staying in the toilet and the behavior rule [“Z, Z, X”, “0, 0, 1”] indicates the state of emitting the cry while gazing around after lying down for a while.

In this embodiment, the animal abnormality information specifying unit 104 may specify the animal abnormality information corresponding to the retrieval observation data and the retrieval animal individual information transmitted from the user terminal device 2. According to this, the abnormality of many types of animals may be detected. The user may also obtain a guide to determine whether the state of the animal is abnormal without medical specialist intervention. In this embodiment, since the animal type information is stored in the animal type information storage unit 103, a piece of animal abnormality information may be applied to a plurality of similar animals. According to this, even the abnormality of a minor animal whose animal abnormality information is gathered with difficulty may be detected if there is the animal abnormality information of the similar animal. In this embodiment, when the environment observation data is stored in the animal abnormality information storage unit 101, the animal abnormality information specifying unit 104 may specify the animal abnormality information corresponding to the observation data transmitted from the user terminal device 2 in consideration of the observation data regarding the external environment. According to this, it becomes possible to retrieve the animal abnormality information with a high degree of accuracy. In this embodiment, when the animal abnormality detection information is stored in the animal abnormality information storage unit 101, the abnormality information transmitting unit 105 may transmit the information including the animal abnormality detection information. According to this, the user may obtain the information regarding the abnormality. In this embodiment, when the diagnostic information is stored in the animal abnormality information storage unit 101, the abnormality information transmitting unit 105 may transmit the diagnostic information on a prior similar case. According to this, the user may virtually receive diagnosis of the medical specialist. In this embodiment, the retrieval observation data receiving unit 102 may receive the retrieval animal observation data and the like within a certain period from a time point at which the user notices the abnormality. According to this, the user may turn on a device to operate only when necessary without always turning on the device. In this embodiment, the abnormality information transmitting unit 105 transmits the abnormality information also to the medical specialist terminal device. According to this, when the abnormality is detected, it is possible to immediately notify the medical specialist of the same. In this embodiment, the animal abnormality information accumulating unit 110 may accumulate the animal abnormality information converted from the sensor data to the feature amount data. According to this, it is possible to compress a data amount stored in the animal abnormality information storage unit 101, thereby improving retrieval efficiency of the animal abnormality information specifying unit 104.

Meanwhile, although a case in which the sensor data storage unit 106, the feature amount data obtaining unit 107, the state rule obtaining unit 108, the behavior rule obtaining unit 109, and the animal abnormality information accumulating unit 110 are provided is described in this embodiment, it is also possible that the animal abnormality detecting device 1 is not provided with the sensor data storage unit 106, the feature amount data obtaining unit 107, the state rule obtaining unit 108, the behavior rule obtaining unit 109, and the animal abnormality information accumulating unit 110. In a case in which the sensor data storage unit 106, the feature amount data obtaining unit 107, the state rule obtaining unit 108, the behavior rule obtaining unit 109, and the animal abnormality information accumulating unit 110 are not provided, the animal abnormality information may be accumulated in the animal abnormality information storage unit 101 through a storage unit, a communication line and the like not illustrated.

Although a case in which the state rule obtaining unit 108 and the behavior rule obtaining unit 109 are provided is described in this embodiment, it is also possible that the animal abnormality detecting device 1 is not provided with the state rule obtaining unit 108 and the behavior rule obtaining unit 109. When the state rule obtaining unit 108 and the behavior rule obtaining unit 109 are not provided, the retrieval observation data receiving unit 102 receives the observation data being the waveform data or the feature amount data.

Although a case in which the feature amount data obtaining unit 107 is provided is described in this embodiment, it is also possible that the animal abnormality detecting device 1 is not provided with the feature amount data obtaining unit 107. When the feature amount data obtaining unit 107 is not provided, the retrieval observation data receiving unit 102 receives the observation data being the waveform data.

Meanwhile, although a case in which the feature amount data obtaining unit 107 obtains the external environment feature amount data is described in this embodiment, it is also possible that the feature amount data obtaining unit 107 does not obtain the external environment feature amount data. When the feature amount data obtaining unit 107 does not obtain the external environment feature amount data, it is also possible that the sensor data storage unit 106 does not store the sensor data regarding the external environment and the state rule obtaining unit 108 and the behavior rule obtaining unit 109 may obtain each rule only from the feature amount data.

Meanwhile, although a case in which the state label setting unit 21 and the state rule specifying unit 22 are included is described in this embodiment, it is also possible that the animal abnormality detecting device 1 does not include the state label setting unit 21 and the state rule specifying unit 22. When the state label setting unit 21 and the state rule specifying unit 22 are not included, the state rule obtaining unit 108 may obtain the state rule without setting the label from the feature amount data.

Although a case in which the behavior label setting unit 23 and the behavior rule specifying unit 24 are included is described, it is also possible that the animal abnormality detecting device 1 does not include the behavior label setting unit 23 and the behavior rule specifying unit 24. When the behavior label setting unit 23 and the behavior rule specifying unit 24 are not included, the behavior rule obtaining unit 109 may obtain the behavior rule without setting the label from the feature amount data.

The software which realizes the animal abnormality detecting device 1 of this embodiment is a program as follows. That is to say, this is the program for allowing a computer capable of accessing the animal abnormality information storage unit in which the animal abnormality information including the animal observation data including one or more pieces of time-series observation data on the animal and the animal individual information being the information regarding the individual attribute of the animal is stored to function as a retrieval observation data receiving unit which receives the retrieval animal observation data including one or more pieces of time-series observation data on the animal and the retrieval animal individual information regarding the individual attribute of the animal, an animal abnormality information specifying unit which specifies the animal abnormality information including the animal observation data and the animal individual information corresponding to the retrieval animal observation data and the retrieval animal individual information received by the retrieval observation data receiving unit, and an abnormality information transmitting unit which transmits the abnormality information being the information regarding the abnormality when the animal abnormality information specifying unit specifies the animal abnormality information.

Meanwhile, in this embodiment, each process (each function) may be realized by a centralized process by a single device (system) or may be realized by dispersed processes by a plurality of devices. In this embodiment, it goes without saying that two or more communicating units in one device may be physically realized by one unit.

In this embodiment, each component may be formed by dedicated hardware, or the component capable of being realized by software may be realized by execution of the program. For example, each component may be realized when a software program recorded on a recording medium such as a hard disk and a semiconductor memory is read by a program executing unit such as a CPU to be executed.

Meanwhile, in the above-described program, a function realized by the above-described program does not include the function which is only realized by the hardware. For example, the function which may be realized only by the hardware such as a modem and an interface card in an obtaining unit to obtain the information and an outputting unit to output the information is not included in the function realized by the above-described program.

FIG. 11 is a schematic diagram of an example of an appearance of the computer which realizes the present invention according to the above-described embodiment by executing the above-described program. The above-described embodiment may be realized by computer hardware and a computer program executed thereon.

In FIG. 11, a computer system 1100 is provided with a computer 1101 including a CD-ROM drive 1105 and a FD drive 1106, a keyboard 1102, a mouse 1103, and a monitor 1104.

FIG. 12 is a view of an internal configuration of the computer system 1100. In FIG. 12, the computer 1101 is provided with an MPU 1111, a ROM 1112 for accumulating a program such as a boot up program, a RAM 1113 connected to the MPU 1111 to temporarily accumulate an instruction of an application program and provide a temporary storage space, a hard disk 1114 accumulating the application program, a system program, and data, and a bus 1115 connecting the MPU 1111, the ROM 1112 and the like to one another in addition to the CD-ROM drive 1105 and the FD drive 1106. Meanwhile, the computer 1101 may include a network card not illustrated which provides connection to a LAN.

The program which allows the computer system 1100 to execute the function of the present invention and the like according to the above-described embodiment may be accumulated in a CD-ROM 1121 or a FD 1122 to be inserted to the CD-ROM drive 1105 or the FD drive 1106 and transferred to the hard disk 1114. In place of this, the program may also be transmitted to the computer 1101 through a network not illustrated to be accumulated in the hard disk 1114. The program is loaded on the RAM 1113 at the time of execution. Meanwhile, the program may be directly loaded from the CD-ROM 1121, the FD 1122, or the network.

It is possible that the program does not necessarily include an operating system (OS), a third party program or the like which allows the computer 1101 to execute the function of the present invention according to the above-described embodiment. It is also possible that the program includes only a part of the instruction to call up an appropriate function (module) in a controlled aspect for obtaining a desired result. The operation of the computer system 1100 is well-known, so that the detailed description thereof is omitted.

It goes without saying that the present invention is not limited to the above-described embodiment, various modifications may be made, and they also are included in the scope of the present invention. In the present invention, “means” of each means may be read as “unit” or a “circuit”.

According to an embodiment of the animal abnormality detecting device and the like according to the present invention, the abnormality of many types of animals may be detected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An animal abnormality detecting device, comprising:
an animal abnormality information storage unit in which animal abnormality information including animal observation data including one or more pieces of time-series observation data on an animal and animal individual information being information regarding an individual attribute of the animal is stored;
a retrieval observation data receiving unit which receives retrieval animal observation data including one or more pieces of time-series observation data on an animal and retrieval animal individual information regarding the individual attribute of the animal;
an animal abnormality information specifying unit which specifies the animal abnormality information including the animal observation data and the animal individual information corresponding to the retrieval animal observation data and the retrieval animal individual information received by the retrieval observation data receiving unit; and
an abnormality information transmitting unit which transmits abnormality information being information regarding abnormality when the animal abnormality information specifying unit specifies the animal abnormality information.

2. The animal abnormality detecting device according to claim 1, further comprising:
an animal type information storage unit in which one or more pieces of animal type information indicating a type of a similar animal are stored, wherein
the animal individual information includes a type of the animal,
the retrieval animal individual information includes a type of the animal, and
the animal abnormality information specifying unit specifies the animal abnormality information including the animal individual information including a type of the animal matching the type of the animal of the retrieval animal individual information or a similar type of animal to the type of the animal of the retrieval animal individual information according to the animal type information and the animal observation data corresponding to the retrieval animal data.

3. The animal abnormality detecting device according to claim 1, wherein
the animal abnormality information further includes environment observation data being observation data regarding an external environment around a same time as the animal observation data included in the animal abnormality information,
the retrieval observation data receiving unit receives the retrieval animal observation data, the retrieval animal individual information, and retrieval environment observation data being the observation data regarding the external environment around the same time as the retrieval animal observation data, and
the animal abnormality information specifying unit specifies the animal abnormality information including the animal observation data, the animal individual information, and the environment observation data corresponding to the retrieval animal observation data, the retrieval animal individual information, and the retrieval environment observation data received by the retrieval observation data receiving unit.

4. The animal abnormality detecting device according to claim 1, wherein
the animal abnormality information includes animal abnormality detection information indicating content of abnormality corresponding to the animal observation data included in the animal abnormality information, and
the abnormality information transmitting unit transmits the abnormality information including the animal abnormality detection information included in the animal abnormality information specified by the animal abnormality information specifying unit.

5. The animal abnormality detecting device according to claim 1, wherein
the animal abnormality information includes diagnostic information indicating a diagnostic result of a medical specialist corresponding to the animal observation data included in the animal abnormality information, and
the abnormality information transmitting unit transmits the abnormality information including the diagnostic information included in the animal abnormality information specified by the animal abnormality information specifying unit.

6. The animal abnormality detecting device according to claim 1, wherein
the retrieval observation data receiving unit receives the animal observation data within a period in which the animal is determined to be in an abnormal state.

7. The animal abnormality detecting device according to claim 1, wherein
the abnormality information transmitting unit transmits the abnormality information to a medical specialist terminal device.

8. The animal abnormality detecting device according to claim 1, wherein
the animal abnormality information storage unit stores the animal observation data including two or more pieces of observation data, the animal abnormality detecting device further comprising:
a sensor data storage unit in which sensor data being data obtained by a sensor when the animal has abnormality and one or more types of time-series data, and the animal individual information being the information regarding the individual attribute of the animal are stored so as to be associated with each other;
a feature amount data obtaining unit which obtains two or more types of feature amount data being time-series data of characteristic values from the one type of sensor data;
a state rule obtaining unit which obtains a state rule being a rule regarding a state of the animal by using the feature amount data;
a behavior rule obtaining unit which obtains a behavior rule being a rule regarding a behavior of the animal by using the feature amount data; and
an animal abnormality information accumulating unit which accumulates the animal abnormality information including the animal observation data including one or more types of observation data being the state rule obtained by the state rule obtaining unit and one or more types of observation data being the behavior rule obtained by the behavior rule obtaining unit and the animal individual information associated with the sensor data used when the observation data is obtained in the animal abnormality information storage unit.

9. An animal abnormality detecting method performed with an animal abnormality information storage unit in which animal abnormality information including animal observation data including one or more pieces of time-series observation data on an animal and animal individual information being information regarding an individual attribute of the animal is stored, the method comprising:
receiving retrieval animal observation data including one or more pieces of time-series observation data on an animal and retrieval animal individual information regarding the individual attribute of the animal;
specifying the animal abnormality information including the animal observation data and the animal individual information corresponding to the retrieval animal observation data and the retrieval animal individual information received at the receiving; and
transmitting abnormality information being information regarding abnormality when the animal abnormality information is specified at the specifying.

10. A computer readable storage medium having stored therein a program which allows a computer capable of accessing an animal abnormality information storage unit in which animal abnormality information including animal observation data including one or more pieces of time-series observation data on an animal and animal individual information being information regarding an individual attribute of the animal is stored to execute a process comprising:
receiving retrieval animal observation data including one or more pieces of time-series observation data on an animal and retrieval animal individual information regarding the individual attribute of the animal;
specifying the animal abnormality information including the animal observation data and the animal individual information corresponding to the retrieval animal observation data and the retrieval animal individual information received in the receiving; and
transmitting abnormality information being information regarding abnormality when the animal abnormality information is specified in the specifying.
